(19) United States
(12) Patent Application Publication
(10) Pub. No.: US 2024/0049093 A1
(43) Pub. Date: Feb. 8, 2024

(54) NETWORK DEVICE, METHOD AND COMPUTER READABLE MEDIUM FOR ACCESSING EXTERNAL NETWORKS

(71) Applicant: ARRIS Enterprises LLC, Suwanee, GA (US)

(72) Inventor: Yang FU, Shenzhen, Guangdong (CN)

(21) Appl. No.: 18/277,461

(22) PCT Filed: Feb. 7, 2022
(86) PCT No.: PCT/US22/15443

§ 371 Date: Aug. 16, 2023

(30) Foreign Application Priority Data
Feb. 18, 2021 (CN) 202110189963.0

(51) Int. Cl. H04W 36/30; H04W 76/19; H04W 24/04; H04W 12/06

(52) U.S. Cl. CPC H04W 36/305; H04W 76/19; H04W 24/04; H04W 12/068

(57) ABSTRACT

A first network device, a method, and a computer-readable medium for accessing an external network. The first network device includes a memory storing instructions, and a processor to execute the instructions to cause the first network device to carry out the following operations: determining a state of an uplink from the first network device to an external network; and in response to determining that the uplink of the first network device fails, switching the working mode of a first radio of the first network device from an access point AP mode to a station STA mode, causing a client device to connect to the first network device via at least one radio other than the first radio; causing a backup device to enable a hotspot mode; and connecting the first network device to the backup device via the first radio to connect to the external network.

### TECHNICAL FIELD

The present disclosure relates to network connections, and more specifically, to network devices, methods, computer-readable media, and computer program products for providing access to external networks.

### BACKGROUND ART

In local area network environments such as homes and offices, there are network devices such as modems and gateways, and their downlinks are connected to various types of client devices through Ethernet, Wi-Fi, Multimedia over Coax Alliance (MoCA) and the like. Their uplinks can be connected to external networks (such as an operator network, the Internet, etc.) through cables, for example, thereby providing these client devices with access to the external networks. For example, an uplink medium of the network device may be a cable that complies with the Data Over Cable System Interface Specification (DOCSIS). However, due to line failures, environmental factors, software module failures, power failures, etc., the uplink may fail. This may cause clients previously connected to the network device to disconnect from the external network.

Generally, these disconnected client devices may need to reconnect to the external network via another device (for example, via another router, gateway, modem, etc.) that can connect to the external network. In this case, clients connected to the network device through wired methods need to change the wired connections, and client devices connected to the network device through wireless methods have to change to select a new network name (for example, Service Set Identifier, SSID) corresponding to another device and enter the corresponding password to re-establish the connection. Since it involves changing the connection for the client, this can be time-consuming and inconvenient, especially for those clients connected to the network device via Ethernet in a wired manner or via MoCA.

### SUMMARY OF THE INVENTION

The present disclosure relates to a network device, a method, a computer-readable medium, and a computer program product for providing access to an external network.

Some aspects of the present disclosure relate to a first network device, which provides a client device in a local area network with access to an external network, the first network device including a memory and a processor. The memory has instructions stored thereon; and the processor is configured to execute the instructions stored on the memory to cause the first network device to carry out the following operations: determining the state of an uplink from the first network device to the external network; and in response to determining that the uplink of the first network device fails: switching the working mode of a first radio of a plurality of radios supported on a wireless module of the first network device from an access point (AP) mode to a station (STA) mode, and causing the client device to connect to the first network device via at least one radio other than the first radio of the plurality of radios; causing a backup device to enable a hotspot mode; and connecting the first network device to the backup device via the first radio, thereby connecting to the external network.

In some embodiments, for the above-mentioned first network device, the processor is further configured to execute the instructions stored on the memory to cause the first network device to perform the following operations: determining whether the uplink of the first network device has recovered from the failure; and in response to determining that the uplink of the first network device has recovered from the failure: switching the working mode of the first radio supported on the wireless module of the first network device from the STA mode to the AP mode, and causing the client device to connect to the first network device via the plurality of radios; causing the backup device to turn off the hotspot mode; and connecting the first network device to the external network via the uplink.

In some embodiments, for the above-mentioned first network device, the plurality of radios include a radio working in 2.4G band and a radio working in 5G band, and the processor is further configured to execute instructions stored on the memory to cause the first network device to perform the following operations: in a case where the backup device has once been connected to the first network device via one of the plurality of radios, using the one of the plurality of radios as the first radio; or in a case where the backup device has never been connected to the first network device, using the radio working in the 2.4G band as the first radio; or according to a preset, using a preset radio of the plurality of radios as the first radio.

In some embodiments, for the above-mentioned first network device, the processor is further configured to execute the instructions stored on the memory to cause the first network device to perform the following operations: when the first radio is switched to the STA mode, randomly generating SSID and password for the Hotspot mode of the backup device; indicating the generated SSID and password to a user; and instructing the user to enable the Hotspot mode on the backup device and configure the hotspot using the generated SSID and password.

In some embodiments, for the above-mentioned first network device, the processor is further configured to execute the instructions stored on the memory to cause the first network device to perform the following operations: instructing the user to enable the Hotspot mode on the backup device and obtain the SSID and password used by the hotspot; and instructing the user to configure the first radio on a configuration page of the first network device using the obtained SSID and password.

In some embodiments, for the above-mentioned first network device, the processor is further configured to execute the instructions stored on the memory to cause the first network device to perform the following operations: when the first radio is switched to the STA mode, randomly generating SSID and password for the Hotspot mode of the backup device; sending the generated SSID and password to the backup device through an application for the first network device installed in the backup device; and instructing the backup device to enable the Hotspot mode and configure the hotspot using the generated SSID and password through the application for the first network device installed in the backup device.

In some embodiments, for the above-mentioned first network device, the processor is further configured to execute the instructions stored on the memory to cause the first network device to perform the following operations: instructing the backup device to enable the Hotspot mode through the application for the first network device installed in the backup device and send the SSID and password used by the hotspot to the application for the first network device; and configuring the first radio using the received SSID and password.

In some embodiments, for the above-mentioned first network device, when the plurality of radios work in the AP mode, the same SSID and password are used for the client device to connect to the first network device.

Some other aspects of the present disclosure relate to a method executed by a first network device, wherein the first network device provides a client device in a local area network with access to an external network, and the method includes: determining the state of an uplink from the first network device to the external network; and in response to determining that the uplink of the first network device fails: switching the working mode of a first radio of a plurality of radios supported on a wireless module of the first network device from an access point AP mode to a station STA mode, and causing the client device to connect to the first network device via at least one radio other than the first radio of the plurality of radios; causing a backup device to enable a hotspot mode; and connecting the first network device to the backup device via the first radio, thereby connecting to the external network.

In some embodiments, the above-mentioned method further includes: determining whether the uplink of the first network device has recovered from the failure; and in response to determining that the uplink of the first network device has recovered from the failure: switching the working mode of the first radio supported on the wireless module of the first network device from the STA mode to the AP mode, and causing the client device to connect to the first network device via the plurality of radios; causing the backup device to turn off the hotspot mode; and connecting the first network device to the external network via the uplink.

In some embodiments, for the above-mentioned method, the plurality of radios include a radio working in 2.4G band and a radio working in 5G band, and switching the first radio to the STA mode further includes: in a case where the backup device has once been connected to the first network device via one of the plurality of radios, using the one of the plurality of radios as the first radio; or in a case where the backup device has never been connected to the first network device, using the radio working in the 2.4G band as the first radio; or according to a preset, using a preset radio of the plurality of radios as the first radio.

In some embodiments, for the above-mentioned method, causing the backup device to enable the Hotspot mode further includes: when the first radio is switched to the STA mode, randomly generating SSID and password for the Hotspot mode of the backup device; indicating the generated SSID and password to a user; and instructing the user to enable the Hotspot mode on the backup device and configure the hotspot using the generated SSID and password.

In some embodiments, for the above-mentioned method, causing the backup device to enable the Hotspot mode further includes: instructing the user to enable the Hotspot mode on the backup device and obtain the SSID and password used by the hotspot; and instructing the user to configure the first radio on a configuration page of the first network device using the obtained SSID and password.

In some embodiments, for the above-mentioned method, causing the backup device to enable the Hotspot mode further includes: when the first radio is switched to the STA mode, randomly generating SSID and password for the Hotspot mode of the backup device; sending the generated SSID and password to the backup device through an application for the first network device installed in the backup device; and instructing the backup device to enable the Hotspot mode and configure the hotspot using the generated SSID and password through the application for the first network device installed in the backup device.

In some embodiments, for the above-mentioned method, causing the backup device to enable the Hotspot mode further includes: instructing the backup device to enable the Hotspot mode through the application for the first network device installed in the backup device and send the SSID and password used by the hotspot to the application for the first network device; and configuring the first radio using the received SSID and password.

In some embodiments, for the above-mentioned method, when the plurality of radios work in the AP mode, the same SSID and password are used for the client device to connect to the first network device.

Some other aspects of the present disclosure relate to a non-transitory computer-readable medium having instructions stored thereon, when executed by a processor of a first network device which provides a client device in a local area network with access to an external network, the instructions causing the first network device to perform the following operations: determining the state of an uplink from the first network device to the external network; and in response to determining that the uplink of the first network device fails: switching the working mode of a first radio of a plurality of radios supported on a wireless module of the first network device from an access point AP mode to a station STA mode, and causing the client device to connect to the first network device via at least one radio other than the first radio of the plurality of radios; causing a backup device to enable a hotspot mode; and connecting the first network device to the backup device via the first radio, thereby connecting to the external network.

In some embodiments, the above-mentioned non-transitory computer-readable medium further comprises instructions that, when executed by the processor of the first network device, cause the first network device to perform the following operations: determining whether the uplink of the first network device has recovered from the failure; and in response to determining that the uplink of the first network device has recovered from the failure: switching the working mode of the first radio supported on the wireless module of the first network device from the STA mode to the AP mode, and causing the client device to connect to the first network device via the plurality of radios; causing the backup device to turn off the hotspot mode; and connecting the first network device to the external network via the uplink.

In some embodiments, for the above-mentioned non-transitory computer-readable medium, the plurality of radios include a radio working in 2.4G band and a radio working in 5G band, and the non-transitory computer-readable medium further includes instructions that, when executed by the processor of the first network device, cause the first network device to perform the following operations: in a case where the backup device has once been connected to the first network device via one of the plurality of radios, using the one of the plurality of radios as the first radio; or in a case where the backup device has never been connected to the first network device, using the radio working in the 2.4G band as the first radio; or according to a preset, using a preset radio of the plurality of radios as the first radio.

In some embodiments, the above-mentioned non-transitory computer-readable medium further comprises instructions that, when executed by the processor of the first network device, cause the first network device to perform the following operations: when the first radio is switched to the STA mode, randomly generating SSID and password for the Hotspot mode of the backup device; indicating the generated SSID and password to a user; and instructing the user to enable the Hotspot mode on the backup device and configure the hotspot using the generated SSID and password.

In some embodiments, the above-mentioned non-transitory computer-readable medium further comprises instructions that, when executed by the processor of the first network device, cause the first network device to perform the following operations: instructing the user to enable the Hotspot mode on the backup device and obtain the SSID and password used by the hotspot; and instructing the user to configure the first radio on a configuration page of the first network device using the obtained SSID and password.

In some embodiments, the above-mentioned non-transitory computer-readable medium further comprises instructions that, when executed by the processor of the first network device, cause the first network device to perform the following operations: when the first radio is switched to the STA mode, randomly generating SSID and password for the Hotspot mode of the backup device; sending the generated SSID and password to the backup device through an application for the first network device installed in the backup device; and instructing the backup device to enable the Hotspot mode and configure the hotspot using the generated SSID and password through the application for the first network device installed in the backup device.

In some embodiments, the above-mentioned non-transitory computer-readable medium further comprises instructions that, when executed by the processor of the first network device, cause the first network device to perform the following operations: instructing the backup device to enable the Hotspot mode through the application for the first network device installed in the backup device and send the SSID and password used by the hotspot to the application for the first network device; and configuring the first radio using the received SSID and password.

In some embodiments, for the above-mentioned non-transitory computer-readable medium, when the plurality of radios work in the AP mode, the same SSID and password are used for the client device to connect to the first network device.

Some other aspects of the present disclosure relate to a computer program product, including instructions that, when executed by one or more processors, cause the execution of the method described above.

### BRIEF DESCRIPTION OF THE ATTACHED DRAWINGS

In order to better understand the present disclosure and show how to implement, description will now be made by way of examples with reference to the accompanying drawings, noting that similar reference numerals refer to the corresponding parts throughout the drawings, in which:

FIG. 1A and FIG. 1B are schematic diagrams showing exemplary network environments according to an embodiment of the present disclosure;

FIG. 2 is a schematic diagram showing a first network device according to an embodiment of the present disclosure;

FIG. 3 is a schematic diagram of an exemplary method executed by the first network device according to an embodiment of the present disclosure;

FIG. 4 is a schematic diagram of another exemplary method executed by the first network device according to an embodiment of the present disclosure;

FIG. 5A and FIG. 5B are schematic diagrams of exemplary configuration pages for the first network device according to an embodiment of the present disclosure.

### SPECIFIC EMBODIMENTS

The following detailed description is made with reference to the attached drawings, and the following detailed description is provided to facilitate comprehensive understanding of various exemplary embodiments of the present disclosure. The following description includes various details for facilitation of understanding. However, these details are merely considered as examples, not for limiting the present disclosure. The present disclosure is defined by the attached Claims and their equivalents. The words and phrases used in the following description are only used to enable a clear and consistent understanding of the present disclosure. In addition, for clarity and brevity, descriptions of well-known structures, functions, and configurations may be omitted. Those of ordinary skill in the art would realize that various changes and modifications can be made to the examples described in the present specification without departing from the gist and scope of the present disclosure.

As described above, the uplink of the network device may fail, which may further cause client devices connected to the external network via the network device to be unable to continue to access the external network. Traditionally, these client devices can be reconnected to the external network by disconnecting these client devices from the network device and connecting to another device that can connect to the external network. However, this method requires the client device to change its original wireless or wired connection methods, which is time-consuming and inconvenient.

Therefore, the present disclosure seeks, when a failure occurs on the uplink of the network device, to switch a first radio of a plurality of radios supported on a wireless module of the network device from the AP mode to the STA mode, and enable the Hotspot mode of a backup device to cause the network device to connect to the backup device via the radio switched to the STA mode, thereby connecting to the external network, and further ensuring that the client device can continue to access the external network conveniently and quickly. In this case, it is possible to continue to provide the client device with access to the external network by changing the uplink medium of the current network device without changing the settings (such as SSID and password) of the client. This is time-saving and convenient.

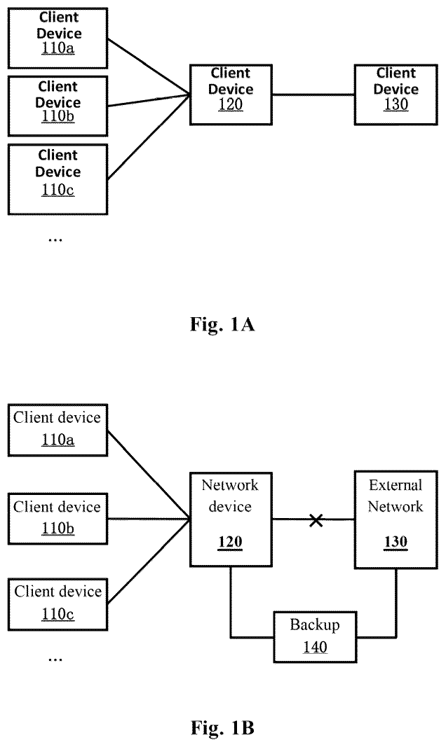

FIG. 1A and FIG. 1B are schematic diagrams showing exemplary network environments according to an embodiment of the present disclosure. Here, FIG. 1A shows an exemplary network environment in a case where the uplink of a network device 120 does not fail or it recovers from a failure; FIG. 1B shows an exemplary network environment in a case where the uplink of the network device 120 fails.

Referring to FIG. 1A, the exemplary network environment may comprise one or a plurality of client devices 110a, 110b, and 110c (hereinafter, collectively referred to as client device 110 for simplicity), the network device 120, and an external network 130. In a case where the uplink of the network device 120 may fail, the exemplary network environment further includes a backup device 140 (see FIG. 1B). In some embodiments, the network device 120 may receive various types of messages from the client device 110 and/or send various types of messages to the client device 110. For example, one or a plurality of client devices 110 may access the external network 130 through the network device 120 and receive one or a plurality of data services, one or a plurality of audio/video services, one or a plurality of home security services and/or other services through the network device 120.

In some embodiments, the client devices 110 may comprise various types of devices, including but not limited to smart phones, cellular phones, smart watches, wearable devices, consumer electronic devices, portable computing devices, desktop computers, laptop computers, sub-notebooks/netbooks, servers, computers, mainframe computers, cloud-based computers, tablet computers and other electronic devices, or smart audio devices, webcams, lighting equipment, smart refrigerators, smart air conditioners, or any other type of home or office equipment that can send and/or receive messages in a variety of ways. The client device 110 may be connected to and communicate with the network device 120 through an Ethernet interface, a Wi-Fi wireless connection, MoCA, etc. Note that the present disclosure does not specifically limit the type of the client device 110.

The network devices 120 may be various types of network devices with wired/wireless access function and capable of transmitting messages between the client devices 110 and the external network, such as an access point (AP) with wireless access function, a transceiver, a controller, a radio node, a router (e.g., a wireless router and mobile hotspot router), a gateway, and a home network controller. In some embodiments, the network device 120 may have an Ethernet interface, a wireless module, etc., and can provide a wired connection for the client through the Ethernet interface, or provide a wireless connection for the client through Wi-Fi. Note that the present disclosure does not specifically limit the type of the network device 120.

The external network 130 may be an operator network, the Internet, etc. According to an embodiment of the present disclosure, in FIG. 1A, when the uplink of the network device 120 does not fail or recovers from a failure, the client device 110 accesses the external network 130 through the network device 120. According to an embodiment of the present disclosure, in FIG. 1B, when the uplink of the network device 120 fails, the network device 120 switches its radio working mode to connect to the backup device 140, and provides the client device 110 with access to the external network 130 through the backup device 140 that can connect to the external network 130. It should be noted that the present disclosure does not specifically define the type of the external network 130.

The backup device 140 may be any type of electronic device that can access the external network 130 and provide the network device 120 with access to the external network 130. The backup device 140 may have a wireless access function such that the network device 120 can access the backup device 140 via its radio working in the STA mode, and the backup device 140 can transmit messages between the network device 120 and the external network 130. The backup device 140 may be, for example, an electronic device with a Hotspot mode such as a smart phone, a cellular phone, and a desktop computer, or an access point, a transceiver, a router, a gateway, a home network controller, etc. that provide wireless access. The backup device 140 and the network device 120 are shown as separate components in FIG. 1B. However, in some embodiments, the backup device 140 may also be a 3G/4G/5G or next-generation communication unit attached to or independent of the network device 120, and the communication unit can access the external network 130 and provide the network device 120 with access to the external network 130. Note that the present disclosure does not specifically limit the type of the backup device 140. In some embodiments, the backup device 140 may be one of the client devices previously connected to the external network through the network device 120.

In an exemplary network environment such as shown in FIG. 1A, when the uplink of the network device 120 fails, it will be time-consuming and hard to switch the client device 110 to connect to another device to reconnect to the external network 130. Therefore, referring to FIG. 1B, when the uplink of the network device fails, in the embodiment of the present disclosure, the client device 110 can be conveniently and quickly connected to the external network 130 by switching one of the plurality of radios supported on the wireless module of the network device 120 from the AP mode to the STA mode and connecting to the external network 130 through the backup device 140.

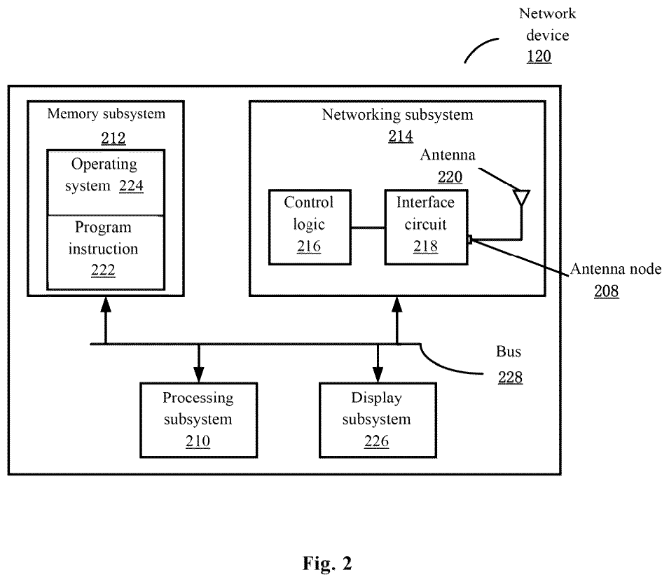

Now, with reference to FIG. 2, description will be made to an embodiment of a network device (referred to herein as a first network device, e.g., the network device 120 shown in FIG. 1A and FIG. 1B), which can perform at least some operations according to the embodiments of the present disclosure in communication technology. The first network device 120 may comprise a processing subsystem 210, a memory subsystem 212, and a networking subsystem 214.

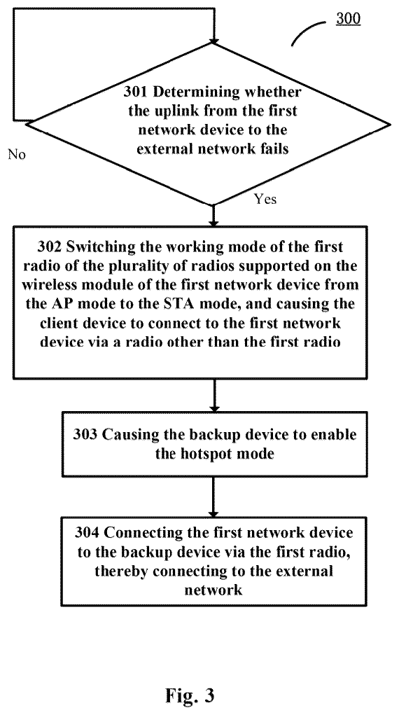

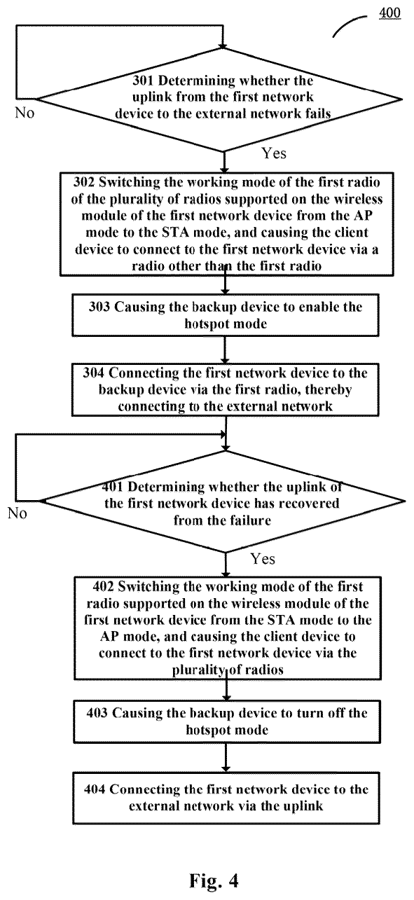

The processing subsystem 210 comprises one or a plurality of devices configured to perform computing operations. The processing subsystem 210 provides various functions of the first network device 120. In some embodiments, the processing subsystem 210 is configured to perform operations for saving power consumption in a wireless network. For example, the processing subsystem 210 may comprise one or a plurality of microprocessors, ASICs, microcontrollers, programmable logic devices, Graphic Processing Units (GPU), and/or one or a plurality of Digital Signal Processors (DSP). The processing subsystem 210 may execute various program instructions stored in the memory subsystem 212 to perform corresponding operations, for example, to execute various program instructions to realize the methods shown in FIG. 3 and FIG. 4.

The memory subsystem 212 comprises one or a plurality of devices for storing data and/or instructions used for the processing subsystem 210 and the networking subsystem 214. For example, the memory subsystem 212 may comprise a dynamic random-access memory (DRAM), a static random-access memory (SRAM), and/or other types of memory (sometimes collectively or individually referred to as “computer-readable storage medium”). In some embodiments, the instructions used in the memory subsystem 212 of the processing subsystem 210 comprise: one or a plurality of program modules or instruction sets (for example, a program instruction 222 or an operating system 224), which can be executed by the processing subsystem 210. It should be noted that one or a plurality of computer programs may constitute a computer program mechanism. In addition, an instruction in the various modules of the memory subsystem 212 may be implemented by the following: advanced programming languages, object-oriented programming languages and/or assembly or machine languages. Moreover, the programming language may be compiled or interpreted, e.g., as configurable or configured (used interchangeably in this discussion), for executing by the processing subsystem 210 to realize the functions of the present disclosure.

In addition, the memory subsystem 212 may comprise mechanism for controlling access to memory. In some embodiments, the memory subsystem 212 comprises a memory hierarchy, and the memory hierarchy comprises one or a plurality of caches coupled to the memory in the first network device 120. In some of these embodiments, one or a plurality of the high-speed caches are located in the processing subsystem 210.

In some embodiments, the memory subsystem 212 is coupled to one or a plurality of high-capacity mass storage devices (not shown). For example, the memory subsystem 212 may be coupled to a magnetic or optical driver, a solid-state driver, or another type of mass storage device. In these embodiments, the first network device 120 may use the memory subsystem 212 as a fast-access storage of frequently used data, while the mass storage device may be used to store infrequently used data.

The networking subsystem 214 comprises one or a plurality of devices configured to be coupled to a wired and/or wireless network and to communicate over the wired and/or wireless network (i.e., to perform network operations), including: control logic 216, an interface circuit 218, and one or a plurality of antennas 220 (or antenna elements). (Although FIG. 2 comprises one or a plurality of antennas 220, in some embodiments, the first network device 110a comprises one or a plurality of nodes that can be coupled to one or a plurality of antennas 220, such as node 208. Therefore, the first network device 110a may or may not comprise one or more antennas 220.) For example, the networking subsystem 214 may comprise a Bluetooth networking system, a cellular networking system (for example, 3G/4G/5G networks, such as UMTS and LTE), a USB networking system, a networking system based on standards described in IEEE 802.11 (for example, Wi-Fi networking system), Ethernet networking system, and/or another networking system.

In the first network device 120, the processing subsystem 210, memory subsystem 212 and networking subsystem 214 are coupled together by a bus 228. The bus 228 may comprise electrical, optical, and/or electro-optical connections of the subsystems through which commands, data and the like may be transmitted. Although only one bus 228 is shown for clarity, different embodiments may comprise different numbers or configurations of electrical, optical, and/or electro-optical connections in the subsystems.

In some embodiments, the first network device 120 comprises a display subsystem 226 for displaying information on a display device, which may comprise a display driver and a display, such as a liquid crystal display and a multi-touch screen, etc.

The first network device 120 may be (or may be comprised in) any electronic device with at least one network interface. For example, the first network device 120 may be (or may be comprised in): a desktop computer, a laptop computer, a sub-notebook/netbook, a server, a computer, a mainframe computer, a cloud-based computer, a tablet computer, a smart phone, a cellular phone, a smart watch, a wearable device, a consumer electronic device, a portable computing device, an access point, a transceiver, a controller, a radio node, a router, a switch, a communication device, a test device, and/or other electronic devices.

Although specific components are used to describe the first network device 120, in alternative embodiments, different components and/or subsystems may exist in the first network device 120. For example, the first network device 120 may comprise one or a plurality of additional processing subsystems, memory subsystems, networking subsystems, and/or display subsystems. Besides, one or a plurality of subsystems may not exist in the first network device 120. Moreover, in some embodiments, the first network device 120 may comprise one or a plurality of additional subsystems not shown in FIG. 2. In addition, although separate subsystems are shown in FIG. 2, in some embodiments, some or all of the given subsystems or components may be integrated into one or a plurality of the other subsystems or components in the first network device 120. For example, in some embodiments, the program instruction 222 is incorporated in the operating system 224, and/or the control logic 216 is incorporated in the interface circuit 218.

FIG. 3 is a schematic diagram of an exemplary method 300 executed by the first network device 120 according to an embodiment of the present disclosure. With reference to the network environment shown in FIG. 1A and FIG. 1B, the first network device 120 executing the method 300 may provide the client device 110 in the local area network with access to the external network 130.

The method 300 may include, in operation 301, determining whether the uplink from the first network device 120 to the external network 130 fails. If yes, continue to execute operation 302; otherwise, return to operation 301 and continue to determine the state of the uplink of the first network device.

The connection of the first network device 120 to the external network 130 may be a wired connection using a cable. For example, the uplink medium of the first network device 120 may be a cable that complies with DOCSIS. Due to line failures, environmental factors, software module failures, power failures, etc., the uplink may fail.

Continuing to refer to FIG. 3, in the case where it is determined that the uplink of the first network device fails, the method 300 may further include, in operation 302, switching the working mode of a first radio of a plurality of radios supported on a wireless module of the first network device 120 from an access point (AP) mode to a station (STA) mode, and causing the client device to connect to the first network device via at least one radio other than the first radio of the plurality of radios.

In the AP mode, the wireless module provides wireless access services to allow the client device to access the network device. Usually when the uplink does not fail or recovers from a failure, the plurality of radios supported on the wireless module work in the AP mode by default. In the STA mode, the first network device is similar to a terminal in the network and can connect to other hotspots or access points via a radio working in the STA mode. The plurality of radios supported on the wireless module of the first network device may include, for example, a radio working in 2.4G band and a radio working in 5G band. Hereinafter, the operation 302 will be described in detail by taking the plurality of radios working in the 2.4G band and working in the 5G band as an example.

The first radio switched to the STA mode is used to access a backup device that can connect to an external network, so that the first network device can access the external network via the backup device. The first radio may be determined in various ways. For example, if the backup device has once been connected to the first network device via the radio working in the 5G band, the first network device knows that the backup device can support the 5G band, and thus the radio working in the 5G band may be used as the first radio. For another example, if the backup device has never been connected to the first network device, since the first network device cannot determine the radio supported by the backup device and the backup device can at least support the 2.4G band by default, the radio working in the 2.4G band may be used as the first radio to ensure that the first network device can access the backup device. For further another example, the user may set one of the radios as the first radio in advance for the first network device to access the backup device according to the user's prior knowledge about the bands supported by the backup device.

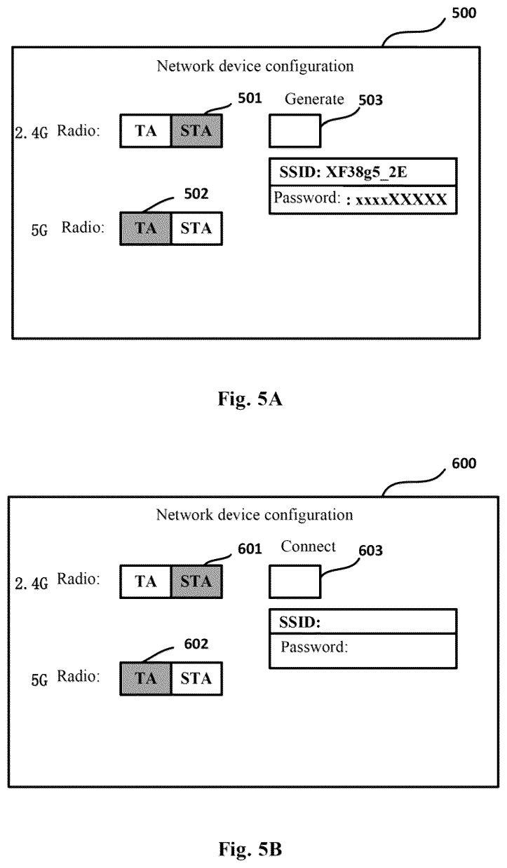

Continuing to refer to FIG. 3, the method 300 may further include, in operation 303, causing the backup device to enable a hotspot mode. Taking a mobile phone as the backup device as an example, when the Hotspot mode is enabled, the mobile phone can connect to the external network through 3G/4G/5G etc., and other terminals can connect to the mobile phone through the hotspot to access the external network. There are many ways to make the backup device enable the hotspot mode, and this will be described in detail below with reference to FIG. 5A and FIG. 5B.

FIG. 5A and FIG. 5B are schematic diagrams of exemplary configuration pages for the first network device according to an embodiment of the present disclosure. For example, referring to FIG. 5A, the 2.4G radio as the first radio is taken as an example. When the radio working in the 2.4G band is switched to the STA mode (501), the first network device randomly generates (503) SSID and password for the Hotspot mode of the backup device, then indicates the generated SSID and password to the user (for example, indicating by displaying the configuration page in FIG. 5A or pushing instruction information containing the SSID and password to the user), and instructs the user to enable the Hotspot mode on the backup device and configure the hotspot using the generated SSID and password.

For another example, referring to FIG. 5B, the 2.4G radio being determined as the first radio is still taken as an example. After the uplink of the first network device fails, the first network indicates the failure to the user by flashing prompts, pushing prompts, etc., and instructs the user to enable the Hotspot mode on the backup device and obtain the SSID and password used by the hotspot (for example, obtaining by enabling the interface display of the hotspot); and instructs the user to configure the radio working in the 2.4G band on the configuration page of the first network device using the obtained SSID and password (for example, at 603, searching for the obtained SSID and entering the corresponding password to join the network).

For further another example, the 2.4G radio being determined as the first radio is still taken as an example. In a case where an application for the first network device is installed in the backup device and the application is running in the backup device, when the radio working in the 2.4G band is switched to the STA mode, the first network device randomly generates the SSID and password for the Hotspot mode of the backup device; then, sends the generated SSID and password to the backup device through the application for the first network device installed in the backup device; and instructs the backup device to enable the Hotspot mode and configure the hotspot using the generated SSID and password through the application for the first network device installed in the backup device (the backup device is required to authorize the corresponding permission to the application).

For further another example, the 2.4G radio being determined as the first radio is still taken as an example. In the case where an application for the first network device is installed in the backup device and the application is running in the backup device, the first network device instructs the backup device to enable the Hotspot mode through the application for the first network device installed in the backup device (the backup device is required to authorize the corresponding permission to the application) and causes the backup device to send the SSID and password used by the hotspot to the application for the first network device; and configures the radio working in the 2.4G band using the received SSID and password. In some embodiments, when the first network device itself has a configuration program or a configuration interface, the first network device can directly use the received SSID and password to configure the radio. In some other embodiments, when the first network device itself does not have a configuration program or a configuration page, it is possible to configure the radio using the received SSID and password through the application for the first network device installed in the backup device.

In the above methods, the method of randomly generating and using the SSID and password to configure the hotspot by the first network device is relatively more random and safer. Configuring the first radio of the first network device according to the SSID and password displayed by the backup device can facilitate presetting the SSID and password when the backup device is selected, thereby providing more convenience.

Continuing to refer to FIG. 3, the method 300 may further include, in operation 304, connecting the first network device to the backup device via the first radio, thereby connecting to the external network. When the first radio is switched to the STA mode, the first network needs to configure an interface and/or a routing table correspondingly such that the first network device can connect to the backup device via the first radio. Taking the 2.4G radio as the first radio as an example, when the first network device connects to the backup device via the radio working in the 2.4G band, a client that previously accessed the first network device via the 2.4G radio will switch to connect to the first network device via the radio working in the 5G band if the client can support the 5G band.

Generally, when the 2.4G radio and the 5G radio work in the AP mode, they can be configured with the same SSID and password for the client device to connect to the first network device. In this way, when the client device switches from the first radio to other radios, it does not need to select a new SSID or configure a new password, which can further provide convenience.

According to the present disclosure, when the uplink of the network device fails, it is possible to continue to provide the client device with connection to the external network by changing the uplink medium of the current network device without changing the settings (such as SSID and password) of the client. This is time-saving and convenient.

Now, another exemplary method 400 for wireless networks according to an embodiment of the present disclosure will be described with reference to FIG. 4. The method 400 may be executed by the first network device 120 shown in FIG. 1A, and the client device therein may be the client device 110 shown in FIG. 1A.

The operations 301 to 304 in FIG. 4 are the same as the corresponding operations in FIG. 3, and will not be described again here.

Referring to FIG. 4, the method 400 further includes, in operation 401, determining whether the uplink of the first network device has recovered from the failure. If yes, continue to execute operation 402; otherwise, return to operation 401 and continue to determine whether the uplink of the first network device has recovered from the failure. The uplink here refers to an uplink through which the first network device communicates with the external network before the failure, for example, an uplink that complies with DOCSIS.

Continuing to refer to FIG. 4, the method 400 further includes, in operation 402, switching the working mode of the first radio supported on the wireless module of the first network device from the STA mode to the AP mode, and causing the client device to connect to the first network device via the plurality of radios. When the first radio is switched back to the AP mode, each client device can access the first network device via the 2.4G radio and 5G radio respectively according to factors such as the supported bands, network load conditions, and rate requirements.

The method 400 further includes, in operation 403, causing the backup device to turn off the hotspot mode, for example, instructing the user to turn off the hotspot mode, or instructing the backup device to turn off the Hotspot mode through an application for the first network device installed in the backup device.

The method 400 further includes, in operation 404, connecting the first network device to the external network via the recovered uplink. In this way, the client device that accesses the first network device through the plurality of radios can connect to the external network via the recovered uplink.

According to the exemplary method shown in FIG. 4, when the uplink of the network device fails, it is possible to continue to provide the client device with connection to the external network by changing the uplink medium of the current network device without changing the settings (such as SSID and password) of the client. This is time-saving and convenient. When the uplink does not fail or has recovered from the failure, the network device returns to a normal working state, and thus can prevent the impact of link failure while meeting the requirement of high-quality access of the client device.

FIG. 5A and FIG. 5B are schematic diagrams of exemplary configuration pages for the first network device according to an embodiment of the present disclosure. According to an embodiment, the plurality of radios supported by the wireless module can be configured and displayed through the configuration page for the first network device. FIG. 5A and FIG. 5B have been described above with reference to the operation 303 of the method 300. In FIG. 5A, the 2.4G radio is determined as the first radio and is switched to the STA mode (501), and the configuration page shows an exemplary implementation in which the first network device randomly generates (503) the SSID and password for the Hotspot mode of the backup device. In FIG. 5B, the 2.4G radio is determined as the first radio and is switched to the STA mode (601), and the configuration page shows an exemplary implementation in which the first radio is configured (603) according to the SSID and password displayed by the backup device. It should be understood that the configuration pages for the first network device shown in FIG. 5A and FIG. 5B are merely illustrative, and other forms of configuration pages can be used.

Although Wi-Fi and/or Ethernet communication protocols are used in the above discussion as illustrative examples, in other embodiments, various communication protocols may be used, and more generally, communication technologies may be used. Therefore, communication technologies can be used in various network interfaces. In addition, although some operations in the aforementioned embodiments are implemented by hardware or software, in general, the operations in the aforementioned embodiments may be implemented in various configurations and frameworks. Therefore, some or all of the operations in the aforementioned embodiments may be implemented by hardware, software, or both. For example, at least some operations in the communication technology can be implemented using the program instruction 222, the operating system 224 (e.g., a driver for the interface circuit 218), or firmware in the interface circuit 218. Alternatively or in addition, at least some operations in the communication technology may be implemented at physical layer, e.g., hardware in the interface circuit 218.

The present disclosure may be realized as any combination of devices, systems, integrated circuits, and computer programs on non-transient computer-readable media. One or a plurality of processors may be realized as an integrated circuit (IC), an application-specific integrated circuit (ASIC) or a large-scale integrated circuit (LSI), a system LSI, a super LSI, or an ultra LSI component that performs some or all of the functions described in the present disclosure.

The present disclosure includes the use of software, applications, computer programs, or algorithms. Software, application programs, computer programs or algorithms can be stored on a non-transient computer-readable medium, so that a computer with one or a plurality of processors can execute the aforementioned steps and the steps described in the attached drawings. For example, one or a plurality of memories store software or algorithms by executable instructions, and one or a plurality of processors can associate the execution of a set of instructions of the software or algorithms to provide monitoring in any number of wireless networks according to the embodiments described in this disclosure.

Software and computer programs (also called programs, software applications, applications, components, or codes) include machine instructions for programmable processors, and may be realized in high-level procedural languages, object-oriented programming languages, functional programming languages, logic programming languages, or assembly languages or machine languages. The term “computer-readable medium” refers to any computer program product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may comprise dynamic random access memory (DRAM), random access memory (RAM), read-only memory (ROM), electrically erasable programmable read-only memory (EEPROM), compact disk read-only memory (CD-ROM) or other optical disk storage devices, magnetic disk storage devices or other magnetic storage devices, or any other medium that can be used to carry or store the required computer-readable program codes in the form of instructions or data structures and can be accessed by a general or special computer or a general or special processor. As used herein, magnetic disks or disks include Compact Discs (CDs), laser disks, optical disks, Digital Versatile Discs (DVDs), floppy disks, and Blu-ray disks, wherein magnetic disks usually copy data magnetically, and disks copy data optically via laser. Combinations of the above are also included in the scope of computer-readable media.

In one or a plurality of embodiments, the use of the words “able”, “can”, “operable as” or “configured as” refers to some devices, logics, hardware and/or components designed to be used in a specified manner. The subject matter of the present disclosure is provided as an example of the apparatus, system, method, and program for performing the features described in the present disclosure. However, in addition to the above features, other features or modifications can be expected. It can be expected that any emerging technology that may replace any of the aforementioned realization technologies may be used to complete the realization of the components and functions of the present disclosure.

In addition, the above description provides examples without limiting the scope, applicability, or configuration set forth in the claims. Without departing from the spirit and scope of the present disclosure, changes may be made to the functions and layouts of the discussed components. Various embodiments may omit, substitute, or add various processes or components as appropriate. For example, features described with respect to some embodiments may be combined in other embodiments.

Similarly, although operations are depicted in a specific order in the attached drawings, this should not be understood as a requirement that such operations should be executed in the specific order shown or in the sequential order, or that all illustrated operations be executed to achieve the desired result. In some cases, multi-tasking and parallel processing can be advantageous.

1. A first network device, which provides client devices within a local area network with access to an external network, the first network device including:
a memory having instructions stored thereon;
a processor, configured to execute the instructions stored on the memory to cause the first network device to perform the following operations:
determining a state of an uplink of the first network device to the external network; and
in response to determining that the uplink of the first network device fails:
switching, the working mode of a first radio of a plurality of radios supported on a wireless module of the first network device, from an access point (AP) mode to a station (STA) mode, and causing the client devices to connect to the first network device via at least one radio of the plurality of radios other than the first radio;
causing a backup device to enable a hotspot mode; and
connecting the first network device to the backup device via the first radio, thereby connecting the first network device to the external network.

2. The first network device according to claim 1, wherein the processor is further configured to execute instructions stored on the memory to cause the first network device to perform the following operations:
determining whether the uplink of the first network device has recovered from the failure; and
in response to determining that the uplink of the first network device has recovered from the failure:
switching the working mode of the first radio supported on the wireless module of the first network device from the STA mode to the AP mode, and causing the client device to connect to the first network device via the plurality of radios;
causing the backup device to turn off the hotspot mode; and
connecting the first network device to the external network via the uplink.

3. The first network device according to claim 1, wherein the plurality of radios include a radio working in 2.4G band and a radio working in 5G band, and the processor is further configured to execute instructions stored on the memory to cause the first network device to perform the following operations:
in a case where the backup device has once been connected to the first network device via one of the plurality of radios, using the one of the plurality of radios as the first radio; or
in a case where the backup device has never been connected to the first network device, using the radio working in the 2.4G band as the first radio; or
according to a preset, using a preset radio of the plurality of radios as the first radio.

4. The first network device according to claim 1, wherein the processor is further configured to execute instructions stored on the memory to cause the first network device to perform the following operations:
when the first radio is switched to the STA mode, randomly generating SSID and password for the Hotspot mode of the backup device;
indicating the generated SSID and password to a user; and
instructing the user to enable the Hotspot mode on the backup device and configure the hotspot using the generated SSID and password.

5. The first network device according to claim 1, wherein the processor is further configured to execute instructions stored on the memory to cause the first network device to perform the following operations:
instructing the user to enable the Hotspot mode on the backup device and obtain the SSID and password used by the hotspot; and
instructing the user to configure the first radio on a configuration page of the first network device using the obtained SSID and password.

6. The first network device according to claim 1, wherein the processor is further configured to execute instructions stored on the memory to cause the first network device to perform the following operations:
when the first radio is switched to the STA mode, randomly generating SSID and password for the Hotspot mode of the backup device;
sending the generated SSID and password to the backup device through an application for the first network device installed in the backup device; and
instructing the backup device to enable the Hotspot mode and configure the hotspot using the generated SSID and password through the application for the first network device installed in the backup device.

7. The first network device according to claim 1, wherein the processor is further configured to execute instructions stored on the memory to cause the first network device to perform the following operations:
instructing the backup device to enable the Hotspot mode through the application for the first network device installed in the backup device and send the SSID and password used by the hotspot to the application for the first network device; and
configuring the first radio using the received SSID and password.

8. The first network device according to claim 1, wherein, when the plurality of radios work in the AP mode, the same SSID and password are used for the client device to connect to the first network device.

9. A method executed by a first network device, wherein the first network device provides a client device in a local area network with access to an external network, and the method includes:
determining the state of an uplink from the first network device to the external network; and
in response to determining that the uplink of the first network device fails:
switching the working mode of a first radio of a plurality of radios supported on a wireless module of the first network device from an access point AP mode to a station STA mode, and causing the client device to connect to the first network device via at least one radio other than the first radio of the plurality of radios;
causing a backup device to enable a hotspot mode; and
connecting the first network device to the backup device via the first radio, thereby connecting to the external network.

10. The method according to claim 9, further including:
determining whether the uplink of the first network device has recovered from the failure; and
in response to determining that the uplink of the first network device has recovered from the failure:
switching the working mode of the first radio supported on the wireless module of the first network device from the STA mode to the AP mode, and causing the client device to connect to the first network device via the plurality of radios;
causing the backup device to turn off the hotspot mode; and
connecting the first network device to the external network via the uplink.

11. The method according to claim 9, wherein the plurality of radios include a radio working in 2.4G band and a radio working in 5G band, and switching the first radio to the STA mode further includes:
in a case where the backup device has once been connected to the first network device via one of the plurality of radios, using the one of the plurality of radios as the first radio; or
in a case where the backup device has never been connected to the first network device, using the radio working in the 2.4G band as the first radio; or
according to a preset, using a preset radio of the plurality of radios as the first radio.

12. The method according to claim 9, wherein causing the backup device to enable the Hotspot mode further includes:
when the first radio is switched to the STA mode, randomly generating SSID and password for the Hotspot mode of the backup device;
indicating the generated SSID and password to a user; and
instructing the user to enable the Hotspot mode on the backup device and configure the hotspot using the generated SSID and password.

13. The method according to claim 9, wherein causing the backup device to enable the Hotspot mode further includes:
instructing the user to enable the Hotspot mode on the backup device and obtain the SSID and password used by the hotspot; and
instructing the user to configure the first radio on a configuration page of the first network device using the obtained SSID and password.

14. The method according to claim 9, wherein causing the backup device to enable the Hotspot mode further includes:
when the first radio is switched to the STA mode, randomly generating SSID and password for the Hotspot mode of the backup device;
sending the generated SSID and password to the backup device through an application for the first network device installed in the backup device; and
instructing the backup device to enable the Hotspot mode and configure the hotspot using the generated SSID and password through the application for the first network device installed in the backup device.

15. The method according to claim 9, wherein causing the backup device to enable the Hotspot mode further includes:
instructing the backup device to enable the Hotspot mode through the application for the first network device installed in the backup device and send the SSID and password used by the hotspot to the application for the first network device; and
configuring the first radio using the received SSID and password.

16. The method according to claim 9, wherein, when the plurality of radios work in the AP mode, the same SSID and password are used for the client device to connect to the first network device.

17. A non-transitory computer-readable medium having instructions stored thereon, when executed by a processor of a first network device which provides a client device in a local area network with access to an external network, the instructions causing the first network device to perform the following operations:
determining the state of an uplink from the first network device to the external network; and
in response to determining that the uplink of the first network device fails:
switching the working mode of a first radio of a plurality of radios supported on a wireless module of the first network device from an access point AP mode to a station STA mode, and causing the client device to connect to the first network device via at least one radio other than the first radio of the plurality of radios;
causing a backup device to enable a hotspot mode; and
connecting the first network device to the backup device via the first radio, thereby connecting to the external network.

18. The non-transitory computer-readable medium according to claim 17, further comprising instructions that, when executed by the processor of the first network device, cause the first network device to perform the following operations:
determining whether the uplink of the first network device has recovered from the failure; and
in response to determining that the uplink of the first network device has recovered from the failure:
switching the working mode of the first radio supported on the wireless module of the first network device from the STA mode to the AP mode, and causing the client device to connect to the first network device via the plurality of radios;
causing the backup device to turn off the hotspot mode; and
connecting the first network device to the external network via the uplink.

19. The non-transitory computer-readable medium according to claim 17, further comprising instructions that, when executed by the processor of the first network device, cause the first network device to perform the following operations:
when the first radio is switched to the STA mode, randomly generating SSID and password for the Hotspot mode of the backup device;
sending the generated SSID and password to the backup device through an application for the first network device installed in the backup device; and
instructing the backup device to enable the Hotspot mode and configure the hotspot using the generated SSID and password through the application for the first network device installed in the backup device.

20. The non-transitory computer-readable medium according to claim 17, further comprising instructions that, when executed by the processor of the first network device, cause the first network device to perform the following operations:
instructing the backup device to enable the Hotspot mode through the application for the first network device installed in the backup device and send the SSID and password used by the hotspot to the application for the first network device; and
configuring the first radio using the received SSID and password.

21. (canceled)
